(19) United States
(12) Patent Application Publication
(10) Pub. No.: US 2024/0258617 A1
(43) Pub. Date: Aug. 1, 2024

(54) Energy Storage Cell, and Method for Producing an Energy Storage Cell

(71) Applicant: Bayerische Motoren Werke Aktiengesellschaft, Muenchen (DE)

(72) Inventors: Niclas EMRICH, Muenchen (DE); Florian KOPP, Moettingen (DE)

(21) Appl. No.: 18/290,855

(22) PCT Filed: Jul. 7, 2022
(86) PCT No.: PCT/EP2022/068926

§ 371 Date: Jan. 22, 2024

(30) Foreign Application Priority Data
Jul. 26, 2021 (DE) 10 2021 119 259.5

(51) Int. Cl. H01M 50/169; H01M 10/0525; H01M 10/0587; H01M 50/107

(52) U.S. Cl. CPC H01M 50/169; H01M 10/0525; H01M 10/0587; H01M 50/107

(57) ABSTRACT

An energy storage cell, more particularly a lithium ion cell, has an especially cylindrical main housing body which extends along a longitudinal axis and defines a chamber in which an electrode material is arranged. The main housing body forms a first pole of the energy storage cell and is electrically conductively connected to the electrode material via a contact element, the contact element being circumferentially joined to the main housing body by pressure welding.

### BACKGROUND AND SUMMARY

The present invention relates to an energy storage cell and to a method for producing an energy storage cell.

Electrical energy storage cells, such as round cells, are used in all kinds of electronic devices and increasingly also for traction batteries in partially or fully electric motor vehicles. EP 3 696 874 A1 and EP 3 726 617 A1 disclose two typical designs of this cell type. A cell coil is located in the interior of a cylindrical housing main body. To form two poles, the cell coil is routed outward at a respective front face via corresponding outgoing conductor elements. A challenge that arises in the production of such cells is that the cells have to be reliably gas-tight. Weld seams can be problematic in this context. The temperature input that occurs during welding can also result in components or parts being subjected to an inadmissibly high load. The housing main bodies often have a coating, for example for protection against corrosion, and this coating may possibly be destroyed during welding.

It is therefore an object of the present invention to provide an energy storage cell and a method for producing an energy storage cell, the aforementioned disadvantages being avoided, and an energy storage cell being made available that meets the highest quality requirements.

This object is achieved by an energy storage cell and by a method in accordance with the independent claims. Further advantages and features will become clear from the dependent claims and also from the description and the attached figures.

According to the invention, an energy storage cell, in particular a lithium-ion cell, comprises an in particular cylindrical housing main body which extends along a longitudinal axis and forms a chamber in which electrode material is arranged, wherein the housing main body forms a first pole of the energy storage cell and is connected electrically conductively to the electrode material via a contact element, and wherein the contact element is connected circumferentially to the housing main body by pressure welding.

According to a preferred embodiment, the energy storage cell is a round cell. Accordingly, the housing main body preferably has a (hollow) cylindrical shape. Preferred materials for the housing main body are nickel, steel, stainless steel or nickel-plated steel. According to a preferred embodiment, the housing main body is made of a steel material, comprising an anti-corrosion layer.

According to a preferred embodiment, the anti-corrosion layer is formed by a nickel layer. Advantageously, this layer is not damaged during pressure welding, unlike, for example, during laser welding. In this context, pressure welding has proven to be particularly gentle on the material. The circumferential connection of the contact element to the housing main body also offers a large degree of design freedom, since the energy storage cell, in particular the round cell, can be designed to be non-conductive at at least one end face. Advantageously, on account of the clean pressing of the components during welding, less particle formation can be expected.

According to one embodiment, the electrode material is an electrode coil. This is also referred to as a jelly roll. As has already been mentioned, according to one embodiment the energy storage cell is a lithium-ion cell. However, the invention is not limited to this cell type. In particular, an energy storage cell of the type in question can also be, for example, an alternative energy storage device such as a supercap.

In the present case, preferred pressure welding methods are, in particular, resistance welding, cold pressure welding, friction welding or ultrasonic welding.

Particularly preferred welding methods are: resistance welding, projection welding or gap welding.

Resistance spot welding, in particular, should be mentioned as a particularly preferred resistance welding method. According to one embodiment, the contact element is connected to the housing main body circumferentially and at points.

In order to achieve a continuous connection or weld seam, a roller electrode can be used, for example.

Projection welding corresponds largely to spot welding. Typically, however, one or more projections or elevations (weld bumps) are introduced into one of the parts that are to be connected. The geometry of these elevations defines the current transition region. Copper electrodes, preferably planar copper electrodes, are used as the electrodes. During the current flow, the aforementioned elevations and/or the projections or weld bumps melt. The material of the elevation, projection or weld bump is pressed into the other component and forms a connection with the latter. At a suitable current strength, several weld projections etc. can advantageously be welded at the same time, which can reduce the cycle time.

In the present context, gap welding should also be mentioned as being advantageous. This is used when parts are connected that are only accessible from one side. Both electrodes are placed on the same surface. In the present case, both electrodes are expediently placed on the outer circumference of the housing main body.

As has already been mentioned, according to one embodiment the connection is spot-welded. Alternatively, it can also be a continuous weld seam.

According to one embodiment, the contact element is round, in particular circular, and is arranged at the end on the electrode material or in particular on the electrode coil. According to one embodiment, the contact element is designed in the shape of a disk, in particular in the shape of a circular disk. The contact element is expediently bonded to the electrode material. Laser welding is preferably used as the joining technique.

According to a preferred embodiment, the aforementioned first pole of the energy storage cell is the negative pole. Accordingly, the contact element is preferably connected to the anode of the electrode material. The contact element can also be referred to as a negative outgoing conductor. In the present case, the negative outgoing conductor is preferably connected electrically conductively to the housing main body, also called the “can”.

According to a preferred embodiment, the contact element, which is in particular disk-shaped, has a contact surface on the circumference, which contact surface bears against an inner side of the main body. According to a preferred embodiment, before the welding, the contact surface of the contact element bears with a force fit on at least some regions of an inner side of the main body. This is advantageous for the welding, especially when welding electrodes cannot be applied from both sides, since it ensures good contact.

According to one embodiment, the contact surface has one or more projections and/or recesses or elevations. These act expediently as the aforementioned weld projections that are required in projection welding. Alternatively or in addition, weld projections can also be formed on the inside of the housing main body.

According to one embodiment, the contact element has a contact web or forms one, the contact web being oriented away from a base surface of the contact element, and the contact surface being formed on the contact web. In the installed position, the contact web is expediently oriented away from the electrode material. The base surface expediently has a round or in particular circular shape. The contact web extends away from the base surface, for example perpendicularly or substantially perpendicularly or also at an angle of <90 degrees. Such an embodiment is particularly advantageous for applying electrodes from both sides. A welding electrode can be applied to the outside of the housing main body, while the second electrode bears on the inside of the contact web. The actual embodiment of the contact web is also dependent in particular on the geometry of the housing main body in this region.

According to one embodiment, the housing main body has an indentation or groove, which is oriented toward the longitudinal axis and preferably runs circumferentially, and on which the contact surface of the contact element bears. According to one embodiment, such an indentation or groove is produced by means of re-shaping. According to one embodiment, the indentation or groove has an approximately V-shaped configuration in cross section. Such a V-shaped configuration has two straight or substantially straight webs, which are connected via a connection region. The contact surface can bear on the connection region or on one of the webs.

According to a preferred embodiment, the contact element has a contact web which extends substantially perpendicularly away and which is connected by means of pressure welding at the connection region of a V-shaped indentation or groove. The aforementioned term “perpendicularly” expediently includes angles in a range of 80 to 100 degrees.

According to a preferred embodiment, the housing main body has a bottom element, which is arranged adjoining the contact element on the housing main body. The bottom element is expediently electrically insulated from the housing main body. The bottom element is expediently fastened to the housing main body by re-shaping of the latter. The two parts are crimped together, for example. The electrical contacting of the housing main body is preferably effected purely circumferentially and not at the end face via the bottom element. The bottom element or the bottom plate can expediently be neutral, which can afford advantages as regards the arrangement and use of the energy storage cell.

As has already been mentioned, according to a preferred embodiment the first pole is the negative pole. The second pole, correspondingly preferably the positive pole, is preferably formed on a cover region of the energy storage cell, opposite the aforementioned bottom element.

According to one embodiment, the cover region is part of the housing main body. The cover region and the housing main body accordingly form a structural unit. According to one embodiment, the structural unit is produced, for example, by means of deep-drawing. The housing main body can also be referred to as being pot-shaped. Alternatively, the cover region is designed as a separately produced cover element, which is fitted in place subsequently.

According to one embodiment, the second pole is formed in the cover region and is electrically insulated from the housing main body.

The invention also relates to a method for producing an energy storage cell, in particular a round cell, comprising the steps of:
arranging a contact element on an electrode material;
arranging the electrode material on an in particular cylindrical housing main body;
cohesively bonding the contact element to the housing main body circumferentially by pressure welding.

According to a preferred embodiment, the contact element is arranged on the electrode material, preferably the electrode coil, before it is arranged in the housing main body. Both contact elements are expediently arranged or fastened on a respective end face of the electrode material/electrode coil, preferably by means of laser welding. This is followed by its arrangement in the in particular cylindrical housing main body. According to a preferred embodiment, the housing main body is pot-shaped, i.e. it not only has a cylindrical peripheral wall, but also a bottom region or cover region.

According to one embodiment, the method comprises the step of:
one-sided or two-sided welding along a circumference of the housing main body.

In the present case, “one-sided” and “two-sided” means the one-sided or the two-sided contact of the (welding) electrodes. At this point, the preferred embodiment also depends in particular on the geometry of the respective contact element. It should be noted at this point that the advantages and features mentioned in connection with the energy storage cell apply analogously and correspondingly to the method, and vice versa.

According to a preferred embodiment, the method comprises the step of:
using cooled welding electrodes.

This can advantageously reduce the temperature input during welding. This is particularly advantageous since it avoids the risk of damage to the electrode material and to the housing main body. Moreover, by virtue of the clean pressing of the components, less particle formation can be expected during welding.

Further advantages and features will become clear from the following description of embodiments of energy storage cells with reference to the attached figures.

### BRIEF DESCRIPTION OF THE DRAWINGS

FIG. 1 shows an overview of an embodiment of a round cell;

FIG. 2 shows two schematic detailed views of embodiments of round cells; and

FIG. 3 shows a further schematic detailed view of an embodiment of a round cell.

### DETAILED DESCRIPTION OF THE DRAWINGS

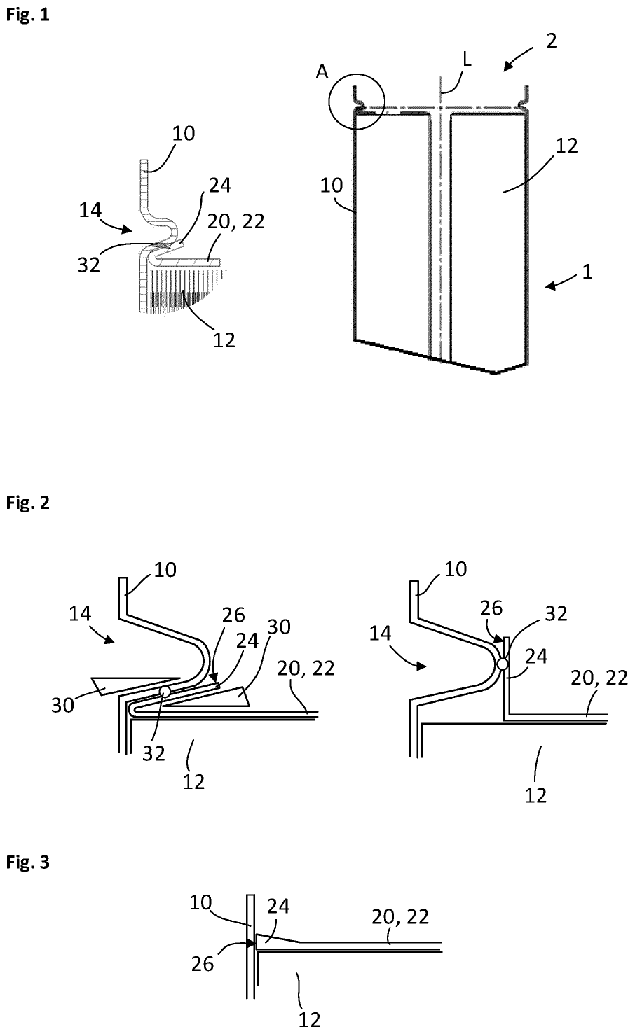

FIG. 1 shows schematically, on the right-hand side of the figure, an energy storage cell 1 in a partial (sectional) view. This is in particular a round cell. It is upside down, so to speak, with a bottom 2 facing upward. The opposite part of the energy storage cell, comprising the cover region, is not shown here. The electrode material 12 is in particular an electrode coil 12, also referred to as a jelly roll. The bottom 2 of the energy storage cell is not yet fully configured in the present case. The housing main body 10 is open. Detail A indicated there is shown enlarged on the left-hand side of the figure. This reveals in particular the section of the housing main body 10 that has an indentation or groove 14. The latter has a substantially V-shaped configuration, comprising two webs which are oriented toward each other and which are connected via a more rounded connection section. A contact web 24 of a contact element 20 bears on the lower of the webs. In particular, a cohesively bonded connection is formed there by means of pressure welding. Reference sign 32 denotes a corresponding weld point. The contact element 20 has a base surface 22 which in the present case is in particular round or in particular circular. The contact web 24 accordingly extends away from the base surface 22. In the present embodiment, the contact web 24 is oriented toward a central axis or longitudinal axis L of the round cell.

In order to complete the bottom 2 of an energy storage cell 1 of the kind outlined here, a suitable bottom element is arranged adjoining the contact element 20, the connection to the housing main body being effected, according to a preferred embodiment, by re-shaping. In particular, the housing main body 10 and the bottom element (not shown here) can be correspondingly crimped together. The bottom element and the housing main body 10 are expediently electrically insulated from each other. Thus, the bottom element can be neutral. In the present case, the housing main body 10 forms the negative pole.

FIG. 2 shows schematically a detailed view as already known from the left-hand side of FIG. 1. In addition to the known features, two welding electrodes 30 are also shown. A contact surface 26, which is formed on the contact web 24 of a contact element 20, can be seen. The contact surface 26 bears against the housing main body 10 or can be brought into contact via the electrodes 30. Since the electrodes 30 cleanly press the two components at the weld point, less particle formation can be expected. In addition, the heat input can be reduced by using cooled electrodes 30. This is advantageous because it reduces the risk of the electrode material 12 or the housing main body 10 being damaged by introduction of an inadmissibly high temperature.

A further embodiment can be seen on the right-hand side of FIG. 2, in which the contact element 20 in particular is designed differently. In the present case, a contact web 24 extends substantially perpendicularly away from a base surface 22 of the contact element 20. The weld point 32 is thereby shifted away from the electrode material 12, which can be advantageous as regards the temperature that is input during welding. Moreover, such a configuration of the contact element 20 enables good accessibility to the weld location from both sides, cf. the weld point 32.

FIG. 3 shows a further embodiment of an energy storage cell, the contact element 20 having a substantially flat design. In the present case, the contact web 24 is designed as a thickening formed at the edge or circumferentially. A contact element 20 designed in this way can be connected to a housing main body 10, of the kind outlined here, for example by means of gap welding.

In principle, it should be noted with reference to FIGS. 2 and 3 that the contact surface 26 of the contact element 20 can be brought into force-fit contact with an inner wall of the housing main body 10 by means of a corresponding dimensional tolerance of the contact element 20, as a result of which the quality of the welding process can be further enhanced.

### LIST OF REFERENCE SIGNS

1 energy storage cell
2 bottom
10 housing main body
12 electrode material, electrode coil
14 indentation, groove
20 contact element
22 base surface
24 contact web
26 contact surface
30 welding electrode
32 weld point
L longitudinal axis

1.-13. (canceled)

14. An energy storage cell, comprising:
a cylindrical housing main body which extends along a longitudinal axis and forms a chamber in which electrode material is arranged; and
a contact element, wherein the housing main body forms a first pole of the energy storage cell and is connected electrically conductively to the electrode material via the contact element; and
a pressure weld by which the contact element is connected circumferentially to the housing main body.

15. The energy storage cell according to claim 14, wherein
the pressure is a resistance weld.

16. The energy storage cell according to claim 14, wherein the connection is a spot weld.

17. The energy storage cell according to claim 14, wherein
the electrode material is an electrode coil, and
the contact element is round and is arranged at an end on the electrode coil.

18. The energy storage cell according to claim 17, wherein
the contact element has a contact surface which bears on an inner side of the main body.

19. The energy storage cell according to claim 18, wherein the contact surface has one or more projections and/or recesses.

20. The energy storage cell according to claim 18, wherein
the contact element has or forms a contact web which is oriented away from a base surface of the contact element, and
the contact surface is formed on the contact web.

21. The energy storage cell according to claim 18, wherein
the housing main body has an indentation or groove which is oriented toward the longitudinal axis and on which the contact surface bears.

22. The energy storage cell according to claim 14, wherein
the housing main body has a bottom element, which is arranged adjoining the contact element on the housing main body.

23. The energy storage cell according to claim 14, wherein
the first pole is a negative pole of the energy storage cell, and
a second pole is formed on a cover region of the energy storage cell.

24. The energy storage cell according to claim 14, wherein the energy storage cell is a lithium ion cell.

25. A method for producing an energy storage cell, comprising the steps of:
arranging a contact element on an electrode material;
arranging the electrode material in a cylindrical housing main body;
cohesively bonding the contact element to the housing main body circumferentially by pressure welding.

26. The method according to claim 25, further comprising the step of:
performing one-sided or two-sided welding along a circumference of the housing main body.

27. The method according to claim 25, further comprising the step of:
using cooled welding electrodes.
